(19) United States
(12) Patent Application Publication
(10) Pub. No.: US 2019/0006087 A1
(43) Pub. Date: Jan. 3, 2019

(54) ARRANGEMENT OF ELECTRICAL CONDUCTORS AND METHOD FOR MANUFACTURING AN ARRANGEMENT OF ELECTRICAL CONDUCTORS

(71) Applicants: THOMAS SUNN PEDERSEN, NEUENKIRCHEN (DE); NORBERT PASCHKOWSKI, GREIFSWALD (DE)

(72) Inventors: THOMAS SUNN PEDERSEN, NEUENKIRCHEN (DE); NORBERT PASCHKOWSKI, GREIFSWALD (DE)

(73) Assignee: MAX-PLANCK-GESELLSCHAFT ZUR FÖRDERUNG DER WISSENSC HAFTEN E.V., MÜNCHEN (DE)

(21) Appl. No.: 15/531,570

(22) PCT Filed: Nov. 23, 2015
(86) PCT No.: PCT/EP2015/002355

§ 371 Date: Jul. 3, 2018

(30) Foreign Application Priority Data
Dec. 3, 2014 (DE) 102014017857.9

(51) Int. Cl. H01F 27/28; H01F 27/24; H01F 27/32; H01F 41/02

(52) U.S. Cl. CPC H01F 27/2876; H01F 27/2823; H01F 41/02; H01F 27/327; H01F 27/24

(57) ABSTRACT

The invention relates to an arrangement of electrical conductors, comprising a conductor bundle having at least one individual electrical cable and at least one cooling line through which a cooling fluid is to flow. In order to thermally connect the conductor bundle to the at least one cooling line, a portion of the at least one cooling line and the conductor bundle are embedded in a low melt temperature metal, wherein an insulating sheath of the at least one individual cable is embodied as plastic insulation, preferably as polyimide insulation or as polyester insulation. The invention further relates to a method for manufacturing such an arrangement.

### CROSS REFERENCE TO RELATED APPLICATIONS

This application claims the benefit of, and incorporates by reference in its entirety, PCT Patent Application No. PCT/EP2015/002355, filed on Nov. 23, 2015 and German Patent Application No. 10 2014 017 857.9, filed on Dec. 3, 2014.

### BACKGROUND

The invention relates to an arrangement of electrical conductors, comprising a conductor bundle having at least one individual electrical cable and at least one cooling line through which a cooling fluid is to flow. The invention further relates to a process for manufacturing such an arrangement of electrical conductors.

Arrangements of electrical conductors in the form of water-cooled electrical wires have been known in the prior art for some time, for example in the form of electrical or electromagnetic coils with a winding formed of wire turns. The resistance of the coil brings about heating of the coil such that coils which are supplied with high power generally have to be cooled to keep the coil within a certain optimum operating temperature range.

It is known from practical experience for cooling such coils to execute the electrical conductors of the coil as hollow conductors, e.g. in the form of hollow copper conductors, through the hollow inside of which wire cooling fluid, generally water, flows to dissipate the Joule heating effect created. It is further known from practical experience to bring the windings of the coil into a flattened geometry, e.g. into a so-called “pancake shape” such that edge cooling of the windings is efficient. At low power densities, it is also known to cool the windings by means of air cooling.

The disadvantage of the hollow copper conductors known in the prior art is that they are relatively inefficient and costly for small coils because the flow resistance ρ rises steeply as the cooling channel radius decreases since according to Poiseuille's equation the flow resistance ρ is proportional to r⁻⁴ (ρ˜r⁻⁴). On the other hand, the flat pancake-like geometries are not practical for many applications. The known air cooling only works for low electrical outputs and for a non-compact geometry.

JP 3841340 B2 proposes a coil with mineral-insulated cables (NIC) in which, for example, a copper conductor is insulated by means of a surrounding layer of magnesium oxide which in turn is surrounded by a copper sheath. For cooling the coil, it is proposed to surround the mineral-insulated cables of the coil with a low melt temperature metal which forms the thermal connection between the cables and one or a plurality of cooling lines of the coil through which water flows. The disadvantage to this approach, however, is that the use of mineral-insulated cables is unsuitable for many applications since they are comparatively expensive and, in particular, small high-performance coils cannot be implemented with a desired power density due to the comparatively large diameter of such mineral-insulated cables.

It is thus an object of the invention to provide an improved arrangement of fluid-cooled electrical conductors with which disadvantages of conventional techniques can be avoided. In particular, the object of the invention is to provide an arrangement of fluid-cooled electrical conductors which can be compactly arranged and simultaneously efficiently cooled even when supplied with a high power density and which is preferably inexpensive to manufacture. It is a further object of the invention to provide a method for manufacturing such an arrangement which is characterised in particular by simplified process control.

These objects are achieved by an arrangement of electrical conductors having the features of the first independent claim and by a method having the features of the second independent claim. Advantageous embodiments and applications of the invention are the subject matter of the dependent claims and are described in greater detail in the description below with partial reference to the figures.

The arrangement of electrical conductors according to the invention comprises a conductor bundle having at least one individual electrical cable and at least one cooling line through which a cooling fluid is to flow. An individual cable is understood as an insulated metal wire, i.e. a metal wire with an insulating sheath. The metal wire can be a copper wire. The at least one cooling channel can be executed as a copper tube. The conductor bundle preferably consists of a plurality of individual electrical cables but can also consist of only one individual cable.

According to general aspects of the invention, the objects referred to are achieved in that for thermally connecting the conductor bundle, i.e. the individual cable or individual cables, to the at least one cooling line, one portion of the at least one cooling line and the individual cables are embedded in a low melt temperature metal, wherein the insulating sheath of the individual cables is embodied as plastic insulation.

Using the arrangement according to the invention, high thermal conduction is implemented from the metal wires of the individual cables to the cooling line, due on the one hand to the usually intrinsically high thermal conductivity of low melt temperature metals and due on the other hand to the thin sheath of insulation on the wires which forms a large contact surface between the plastic insulation of the metal wires and the low melt temperature metal.

Surprisingly, the inventors discovered that despite the thin plastic insulation of conventional wires, no short circuits occur when they are embedded in an electrically conductive molten low melt temperature metal. Experiments within the scope of the invention showed that the electrical plastic insulation of commercially available electrical wires is sufficient to prevent such short circuits.

Especially preferred embodiments provide in this case that the plastic insulation is a polyimide insulation or a polyester insulation. An especially advantageous variant of a polyimide insulation is a sheath of extruded Kapton®. An especially advantageous variant of the polyester insulation is a polyester lacquer insulation. These variants have the advantage that no disruptive chemical reactions take place between a polyimide or polyester insulation and common low melt temperature metals, particularly a tin-bismuth alloy.

These insulation variants further have the advantage over a mineral insulation that both insulation variants enable unlimited wire bending radii and surprisingly are considerably more robust than mineral insulations with regard to short circuits caused by porosity or cracks.

A particular advantage of polyester lacquer insulated wires is also their low manufacturing costs, making them generally cheaper than typical mineral-insulated cables by up to a factor of 50.

A further advantage of the invention is that during cooling by means of a separate dedicated cooling channel which is thermally connected to the individual cable via the low melt temperature metal, the diameter of said cooling channel can be specified independently of the diameter of the wires which permits substantially more efficient optimisation of the cooling and specification of the voltage/current intensity ratio independent thereof. This advantage is particularly significant for small coils due to the strong light linearity of the water flows, cf. Poiseuille's equation.

The concept of a low melt temperature metal (also abbreviated subsequently as LMTM) is also intended to include low melt temperature metal alloys. Thus a low melt temperature metal is understood as a metal or an alloy with a low melting temperature. Such metals are also referred to as low-melting metals or metal alloys. The low melt temperature metal used for thermally connecting the individual cables has in particular a high thermal conductivity.

The low melt temperature metal preferably has a melting point below 260° C., further preferably a melting point below 150° C. The low melt temperature metal can be, for example, a tin-bismuth alloy, a tin-lead alloy or a soldering alloy. Within the scope of the invention, the low melt temperature metal can contain at least one metal or one alloy selected from the group tin, tin-lead, tin-zinc or tin-bismuth.

The specified maximum target operating temperature of the material of the insulating sheath is preferably greater than the melting temperature of the low melt temperature metal, such that it is ensured that the insulation of the individual cables is not damaged when the molten metal is introduced.

The conductor bundle is permanently positively bonded to the portion of the at least one cooling line preferably by casting with the low melt temperature metal to ensure a good thermal connection.

A highlighted application of the invention relates to an embodiment of the arrangement of electrical conductors as an electrical or electromagnetic liquid-cooled coil in which the conductor bundle having the at least one individual electrical cable forms at least one winding of the coil. In this case, the portion of the cooling line embedded in the low melt temperature metal is preferably circular.

A coil executed in this manner can be provided compactly and inexpensively due to the use of plastic-insulated wires and can simultaneously be provided with high performance due to the efficient cooling. Within the scope of the invention, it is possible in this case for the coil to have a hollow torus-shaped coil form, as the carrier of the at least one winding of the coil, which encloses said at least one winding and the embedded portion of the cooling line. Such a hollow torus-shaped coil form further offers the advantage that it can simultaneously serve as a casting mould during manufacture of the coil. The cooling line can be executed, for example, as a copper tube and/or run substantially in the centre of the hollow space of the coil form and thus be evenly surrounded by the windings of the coil. An inflow and a drain tube, which can be used for evacuation of the coil form as part of a vacuum casting process and for introduction of the molten low melt temperature metal, can further be attached to the coil form.

According to the invention, a method for manufacturing the inventive arrangement of electrical conductors, as disclosed above, is also proposed. According to general aspects of the invention, embedding of the conductor bundle or the individual cables and the portion of the at least one cooling line in the low melt temperature metal takes place by means of a vacuum casting process.

Introduction of the molten low melt temperature metal by means of a vacuum casting process prevents the formation of air bubbles and further ensures that no gaps occur between wires even at constrictions.

An advantageous variation provides in this case for the coil form to be configured vacuum-tight and can thus be used as a casting mould. The vacuum casting process can comprise the following steps:

An inflow tube and an outflow tube, each of which fluidically communicates with the hollow space of the coil form, are attached to said coil form. Before evacuation of the coil form, the inflow tube is sealed with a low melt temperature metal, preferably with the low melt temperature metal which is introduced into the coil form in the subsequent vacuum casting process for thermal connection thereof. The inflow tube can be sealed or plugged, for example, by dipping the opening of the inflow tube into a small quantity of molten low melt temperature metal which subsequently solidifies again and thereby seals the opening.

The inside of the coil form, in which the coil windings and a portion of cooling line are located, is then evacuated via the outflow tube. In this case, it has been shown that the evacuation achievable with a low-vacuum pump is sufficient. After evacuation of the coil form, the low melt temperature metal sealing the inflow tube is melted, e.g. by supplying it with current and thereby heating the coil up to a temperature slightly above the melting temperature of the LMTM. Before re-opening the inflow tube by melting the LMTM, the inflow tube is positioned such that its inlet opening is dipped into a reservoir of liquid LMTM such that, after melting of the LMTM in the inflow tube, the molten LMTM, driven by the vacuum force in the coil form, flows out of the reservoir into the hollow space of the coil form until the remaining hollow space in the coil form is completely filled in with the LMTM. The LMTM then becomes solid by cooling down.

### BRIEF DESCRIPTION OF THE FIGURES

To avoid repetition, any features disclosed purely in accordance with the device shall be deemed disclosed and claimable also as part of the manufacturing process. Further details and advantages of the invention are described in the following with reference to the associated drawings. The drawings show:

FIG. 1 a schematic sectional view through a portion of the coil according to an embodiment of the invention;

FIG. 2 a perspective view of a coil, wherein for illustration purposes a quarter of the outer body and the LMTM filling have been omitted;

FIG. 3 a flow diagram to illustrate the steps of the manufacturing process; and

FIG. 4 a schematic perspective view of the coil according to a further embodiment of the invention.

### DETAILED DESCRIPTION

The following Figures describe a water-cooled coil as a highlighted application example of the invention and its manufacturing process. Identical or functionally equivalent elements are denoted by the same reference numbers in all Figures.

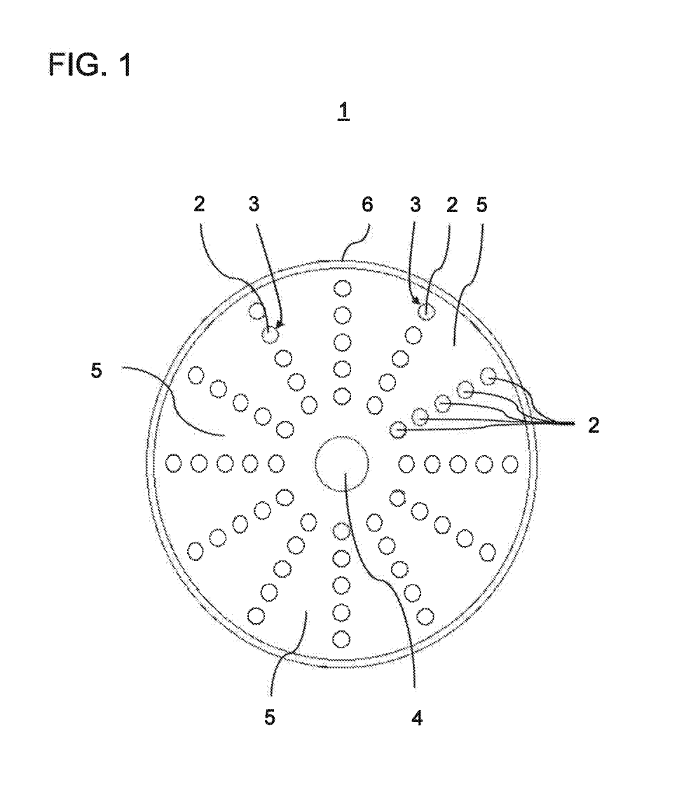

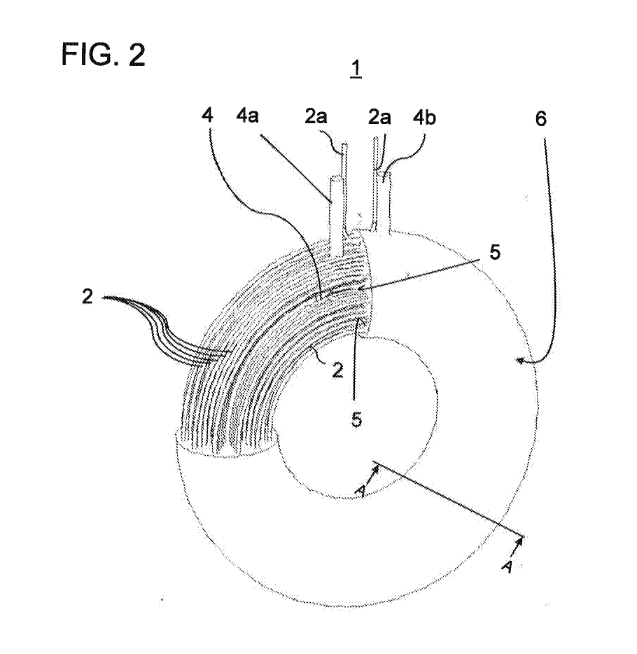

FIGS. 1 and 2 schematically illustrate an embodiment of the water-cooled coil. The coil 1 comprises an outer body 6 of copper which is hollow torus-shaped. FIG. 1 shows a cross section along the sectional plane A-A of FIG. 2 to illustrate a meridian of the torus, while FIG. 2 shows a perspective view of the coil 1 in which an eighth of the outer body 6 and the low melt temperature metal 5 at this point were omitted to make the inner structure clear.

It can be seen in FIGS. 1 and 2 that a circular portion 4 of the cooling line through which a cooling fluid, preferably water, is to flow, runs in the centre of the internal hollow space formed by the coil outer body 6. The portion 4 of the cooling channel is formed by a single winding of a hollow copper pipe with a diameter of 3 mm. Water enters the circular line portion 4 via an inflow line 4a and is routed out of the coil form 6 again via an outflow line 4b. The remainder of the cooling circuit, which is designed in the manner known per se, is not illustrated.

Arranged around the water cooling tube 4 are a plurality of windings of a copper wire such that in the illustration in FIG. 2 the circular line portion 4 of the cooling tube is largely covered by the windings. There are 60 windings in the present example. The windings thus consist of individual cables 2 whose electrical conductors are formed from copper wires which are sheathed with a polyimide insulation or a polyester insulation 3. The individual cables 2 or windings are permanently positively bonded to the circular portion 4 of the cooling line by casting with a low melt temperature metal (LMTM) 5. The LMTM 5 thus fills in all the interstitial spaces between the cables and the portion 4 of the cooling line and thus conducts the heat of the individual cables 2 created during operation of the coil to the portion 4 of the cooling line through which water flows when the coil is operating.

It should be emphasised that FIGS. 1 and 2 merely show a schematic diagram and the actual distances between the windings are smaller than actually illustrated. The diameter of the individual cables 3, for example, is 1.2 mm in the present embodiment while the diameter of the cooling line is 4 mm. These details are merely by way of example and can be modified according to the coil depending on the area of application.

FIG. 2 additionally shows the two electrical connection cables 2a for supplying the windings with current. In the present embodiment, extruded Kapton® was used as an example of a polyimide insulation. According to the manufacturer's data, the maximum target operating temperature of the Kapton® wire is 230° C. and therefore significantly below the melting temperature of the tin-bismuth alloy used. The Kapton® insulation is thus not damaged when a molten tin-bismuth alloy is introduced.

A polyester lacquer insulation of the type W210 by Stefan Maier GmbH was used as a polyester example. A tin-bismuth alloy, which was introduced into the coil form 6 using a vacuum casting process, was used as the LMTM 5.

Such water-cooled coils are used in different technical fields, for example, physics experiments, compact high-power transformers or various compact actuator devices.

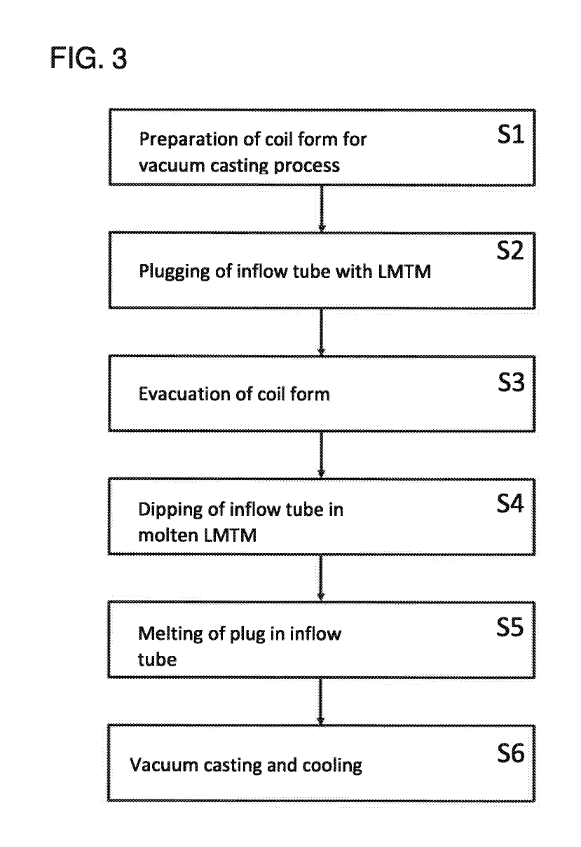

An advantageous manufacturing process of the coil 1 is described in greater detail below based on FIG. 3.

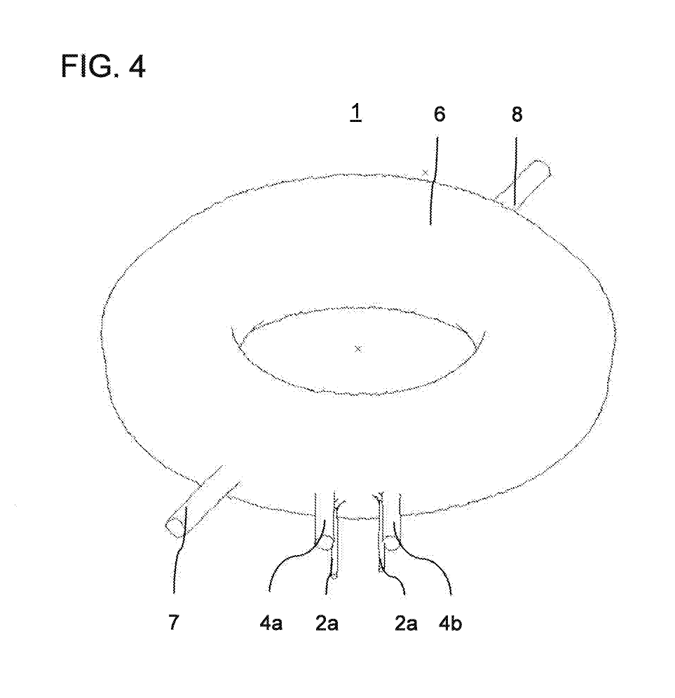

The coil form 6 is prepared for the vacuum casting process in step S1. In this case, the windings of the individual cables 2 described above and the circular portion 4 of the cooling tube are introduced into the hollow space of the coil outer body 6. For this purpose, the coil outer body 6 can be formed, for example, from two half-shells, which are placed around the individual cables 2 and the cooling tube portion 4, and are joined together vacuum-tight by soldering. The coil outer body 6 has through-holes for the inflow line and the outflow line 4b of the cooling circuit. In addition, an inflow tube 7 (see FIG. 4) and an outflow tube 8 are attached to the coil form 6. The outflow tube 8 is also used as a drain tube for a connected low-vacuum pump.

The opening of the inflow tube 7 was narrowed to an approximately 1 mm² gap such that the LMTM flow rate (see step S6) is reduced by one to two orders of magnitude and to approximately one litre per minute. It is possible thereby to ensure that the LMTM flows in and out in a controlled manner during the casting step and does not reach the connected low-vacuum pump but rather instead plugs the drain tube 8 once the coil form 6 has been completely filled. As a result, vacuum bubbles in the coil and damage to the low-vacuum pump can be prevented.

Subsequently, in step S2, the inflow tube 7 is sealed by dipping the inflow tube 7 into a small quantity of the LMTM, here a tin-bismuth alloy. The molten tin-bismuth alloy then solidifies in the inflow tube 7 and plugs it. Then in step S3, the drain tube 8 is connected to a low-vacuum pump and the coil form 6 is evacuated using the coil winding, i.e. it is pumped dry with the low-vacuum pump.

The previously plugged opening of the inflow tube 7 is then dipped in step S5 into a reservoir containing the LMTM in the molten state. In addition, the coil is heated by supplying it with current to a temperature of up to 140° C., i.e. a temperature which is slightly above the melting temperature of the LMTM, in this case 132° C. As a result, the plug of the inflow tube 7 made of the LMTM material melts such that the LMTM from the reservoir, driven by the vacuum forces, now flows via the no longer blocked inflow tube 7 into the interior of the coil form 6 and completely fills it such that the windings of the individual cables 2 and the cooling tube 4 in the interior of the coil form 6 are completely embedded with the LMTM and as a result are thermally joined to each other. The coil is then cooled so that the LMTM becomes solid (step S6).

The separation between the evacuation of the inner volume of the coil form 6 (step S3) and the subsequent pouring in of the molten LMTM (step S6) reliably prevents the formation of air bubbles and improves the heat transfer from the coil to the cooling line and therefore into the cooling fluid.

FIG. 4 shows the coil 1 from FIG. 2 with the difference that, as already mentioned above, the inflow tube 7 and the outflow tube 8 are additionally provided on the coil outer body 6 and can be removed after the casting process is discharged.

Although the invention has been described with reference to particular embodiments, it is apparent to a person skilled in the art that various changes can be made and equivalents can be used as a substitute without departing from the scope of the invention. In addition, many modifications can be carried out without departing from the associated scope. Consequently, the invention should not be limited to the embodiments disclosed but rather the invention should include all embodiments falling within the scope of the appended claims. In particular, the invention also claims protection for the subject matter and the features of the dependent claims regardless of the claims referred to.

1. An arrangement of electrical conductors, comprising
a conductor bundle having at least one individual electrical cable; and
at least one cooling line through which a cooling fluid is to flow,
wherein in order to thermally connect the conductor bundle to the at least one cooling line, a portion of the at least one cooling line and the conductor bundle are embedded in a low melt temperature metal; and
wherein the insulating sheath of the at least one individual cable is embodied as plastic insulation.

2. The arrangement of electrical conductors according to claim 1, wherein the plastic insulation is a polyimide insulation or a polyester insulation.

3. The arrangement of electrical conductors according to claim 1, wherein the conductor bundle is permanently positively bonded to the portion of the at least one cooling line by casting with the low melt temperature metal.

4. The arrangement of electrical conductors according to claim 2, wherein
the polyimide insulation is a sheath of extruded Kapton® or wherein
the polyester insulation is a polyester lacquer insulation.

5. The arrangement of electrical conductors according to claim 1, wherein
the low melt temperature metal has a melting point below one of 260° C. or 150° C.

6. The arrangement of electrical conductors according to claim 1, wherein the arrangement is configured as an electrical or electromagnetic liquid-cooled coil in which the conductor bundle having the at least one individual electrical cable forms at least one winding of the coil.

7. The arrangement of electrical conductors according to claim 6, wherein a hollow torus-shaped coil form, surrounding the at least one winding and the embedded portion of the cooling line, as the carrier of said at least one winding.

8. The arrangement of electrical conductors according to claim 1, wherein the electrical conductors of the individual cables are copper wires.

9. The arrangement of electrical conductors according to claim 1, wherein the low melt temperature metal is one of a tin-bismuth alloy, a tin-lead alloy and a soldering alloy.

10. The arrangement of electrical conductors according to claim 1, wherein the low melt temperature metal contains at least one metal or one allot selected from the group tin, tin-lead, tin-zinc and tin-bismuth.

11. A method for manufacturing an arrangement of electrical conductors according to claim 1, wherein embedding of the conductor bundle and the portion of the at least one cooling line in the low melt temperature metal is carried out by means of a vacuum casting process.

12. A method for manufacturing an arrangement according to claim 6, wherein the coil form is designed to be vacuum-tight, the method comprising the following steps of the vacuum casting process:
Arranging of an inflow tube and an outflow tube on the coil form;
Plugging of the inflow tube with a low melt temperature metal;
Evacuating of the coil form via the outflow tube;
Melting of the low melt temperature metal in the inflow tube which is dipped into a reservoir of low melt temperature metal such that, after melting of the low melt temperature metal in said inflow tube, molten low melt temperature metal, driven out of the reservoir by vacuum forces, flows into the hollow space of the coil form.
